(19) United States
(12) Patent Application Publication
(10) Pub. No.: US 2005/0265633 A1
(43) Pub. Date: Dec. 1, 2005

(54) Low latency pyramid processor for image processing systems

(75) Inventors: Michael Raymond Piacentino, Robbinsville, NJ (US); Gooitzen Siemen van der Wal, Hopewell, NJ (US); Peter Jeffrey Burt, Princeton, NJ (US); James Russell Bergen, Hopewell, NJ (US)

Correspondence Address: MOSER IP LAW GROUP / SARNOFF CORPORATION, 1040 BROAD STREET, 2ND FLOOR, SHREWSBURY, NJ, 07702, US

(73) Assignee: Sarnoff Corporation

(21) Appl. No.: 11/136,908

(22) Filed: May 25, 2005

Related U.S. Application Data
(60) Provisional application No. 60/574,175, filed on May 25, 2004.

(51) Int. Cl. G06K 9/36; G06K 9/46; G06K 9/40; G06K 9/32

(52) U.S. Cl. 382/302; 382/265; 382/294; 382/240

(57) ABSTRACT

A video processor that uses a low latency pyramid processing technique for fusing images from multiple sensors. The imagery from multiple sensors is enhanced, warped into alignment, and then fused with one another in a manner that provides the fusing to occur within a single frame of video, i.e., sub-frame processing. Such sub-frame processing results in a sub-frame delay between a moment of capturing the images to the display of the fused imagery.

### CROSS-REFERENCE TO RELATED APPLICATIONS

This application claims benefit of U.S. provisional patent application Ser. No. 60/574,175, filed May 25, 2004, which is herein incorporated by reference.

### GOVERNMENT RIGHTS IN THIS INVENTION

This invention was made with U.S. government support under contract number NBCH030074, Department of the Interior. The U.S. government has certain rights in this invention.

### BACKGROUND OF THE INVENTION

1 . Field of the Invention

Embodiments of the present invention generally relate to an improved method for performing video processing and, more particularly, the invention relates to a low latency pyramid processor in an image processing system.

2 . Description of the Related Art

Pyramid processing of images generally relies upon a deconstruction process that repeatedly Laplacian filters an image frame of a video sequence. Such filtering produces, for each video frame, a sequence of sub-images representing “Laplacian levels”. Such pyramid processing is disclosed in commonly assigned U.S. Pat. Nos. 6,647,150, 5,963,675 and 5,359,674, hereby incorporated by reference herein. In these patents, a pyramid processor is used to perform Laplacian filtering, and then process the various Laplacian sub-images in various ways to provide enhanced video processing. In U.S. Pat. No. 5,488,674, pyramid processing is applied to two independent sequences of imagery, the processed images are aligned on a frame-by-frame basis, and then fused into a composite image. The image fusing is performed on a sub-image basis. Such a fusing process can be applied to sensors (cameras) that image a scene using different wavelengths, such as infrared and visible wavelengths, to create a composite image containing imagery from both wavelengths.

These image processing systems require that an entire frame of information be available from the sensors before processing begins (i.e., frame-processing). As such, the frames of data as they are being processed within the system must be stored and then retrieved for further processing. Such frame-based processing uses a substantial amount of memory and causes a delay from the moment the image is captured to the output of the image processing system. The processing time is generally more than one frame and a half. For use in many real-time display systems, this delay is unacceptable.

Therefore, there is a need in the art for a low latency pyramid processor for an image processing system.

### SUMMARY OF THE INVENTION

The present invention is a video processor that uses a low latency pyramid processing technique for fusing images from multiple sensors. In one embodiment of the invention, the imagery from multiple sensors is enhanced, warped into alignment, and then fused with one another in a manner that provides the fusing to occur within a single frame of video, i.e., sub-frame processing. Such sub-frame processing results in a sub-frame delay between the moment of capturing the images to the display of the fused imagery.

One specific application of the invention is a Vision Aided Navigation (VAN) system that combines vision information with more traditional position location systems (e.g., initertial navigation, satellite navigation, compass and the like). The information generated by a multi-sensor vision system is combined, on a weighted basis, with navigation information from other systems to produce a robust navigation system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a high-level block diagram of an exemplary embodiment of the present invention within an image processing system;

FIG. 2 is a functional detailed block diagram of a video processor in accordance with the present invention;

FIG. 3 depicts a functional block diagram of the image fusing portion of the video processor of FIG. 2;

FIG. 4 depicts a functional block diagram of the pyramid processing process used by the present invention;

FIG. 5 depicts a hardware diagram of a portion of the pyramid processor; and

FIG. 6 depicts a block diagram of an exemplary embodiment of an application for the video processor in a vision aided navigation system.

### DETAILED DESCRIPTION

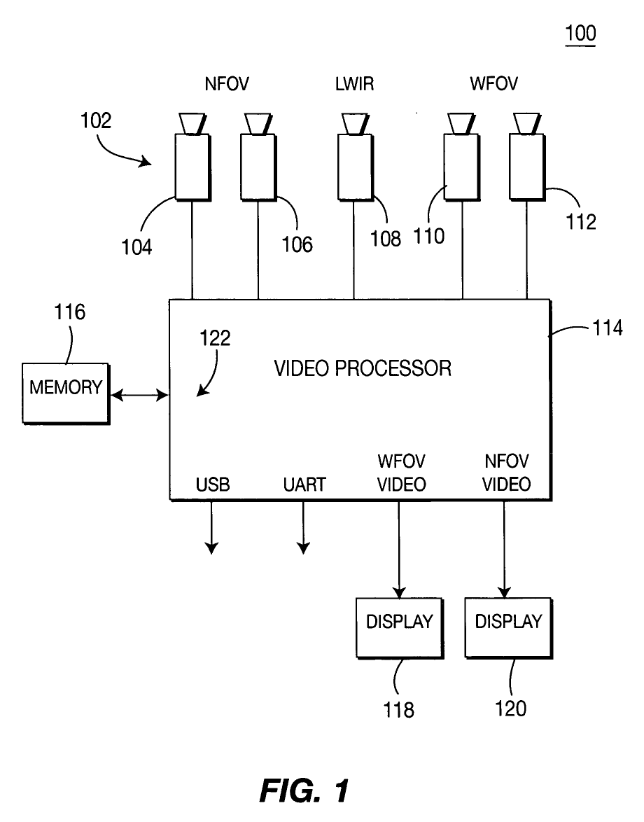

FIG. 1 depicts a high-level block diagram of a video processing system 100 comprising a plurality of sensors 104, 106, 108, 110,and 112 (collectively sensors 102), a video processor 114, memory 116, and one or more displays 118, 120. The video processor 114 is generally, but not necessarily a single integrated circuit. As such, the system 100 can be assembled into a relatively compact space, e.g., on a hand-held platform, helmet platform, platform integrating a sensor and the video processor (system on a chip platform) and the like.

Specifically, multiple sensor imagery from sensors 102 is combined and fused into one or more display images. In an exemplary embodiment shown in FIG. 1, the video processor 114 forms a stereo image, i.e., a right and left image for display on a heads-up display in front of each eye of a user. Although any form of sensor can be used in the system 100, in an exemplary embodiment, the video sensors 102 include a pair of narrow field of view (NFOV) cameras 104 and 106, a long-wave infrared (LWIR) camera 108, and a pair of wide field of view (WFOV) cameras 110 and 112. These cameras produce, for example, 1024 line by 1280 pixel images at a thirty hertz rate. The use of both NFOV and WFOV cameras provides the ability to use a display technique known as a dichoptic display, where the NFOV cameras provide high-resolution imagery with a 30 degree field of view, and the WFOV cameras provide lower resolution imagery with a 70 degree field of view. Aligning and fusing the images from the two pairs of cameras and displaying a NFOV image at one eye of the user and a WFOV image at the other eye of the user causes the user's brain to combine the views to form a composite view having a WFOV image with high-resolution information in the center.

In one embodiment of the invention, the cameras are long-wavelength infrared (LWIR), short-wavelength infrared (SWIR), and visible near infrared (VNIR) wavelength. More specifically, there is a SWIR NFOV camera 104, a SWIR WFOV camera 110, a NVIR NFOV camera 106, a NVIR WFOV camera 112, and a single LWIR camera 108. The video processor 114 processes the video streams from all of the cameras, and fuses those streams into video displays for the right and left eye. Specifically, the LWIR NFOV, SWIR NFOV, and the LWIR images are fused for display over one eye and the LWIR WFOV, SWIR WFOV, and the LWIR images are fused for display over the other eye. In other implementations, the imagery from the various sensors can be fused for display onto N displays, where N is an integer greater than zero.

Although the present embodiment shows five different cameras 102, those skilled in the art will understand that a single camera pair could be used with the video processor of the present invention. In one embodiment, the charge coupled (CCD) arrays of the cameras 102 are mounted directly to the video processor 114 (system on a chip technology). In other embodiments, the CCD arrays are mounted remotely from the video processor 114. To facilitate near real-time image processing and display on a sub-frame basis, the cameras 102 are generally mounted to be spatially aligned with one another such that the images produced by the cameras are captured of the same scene at the same time in a coarsely aligned manner.

The video processor 114 has a number of input/output ports 122, one of which couples to external memory 116 (e.g., flash or other random access memory), while the other ports provide USB and UART data port support.

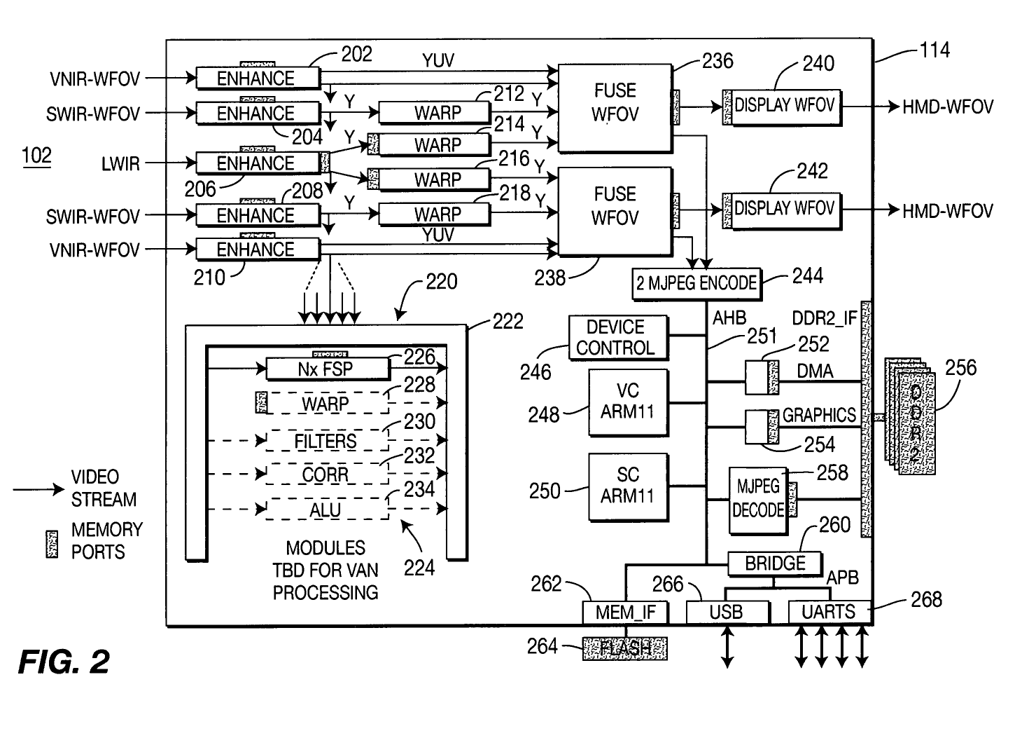

FIG. 2 depicts a detailed functional block diagram of the video processor 114. The video processor 114 accepts inputs from the multiple sensors 102. The “pipelined” process that aligns and fuses the images comprises enhancement modules 202, 204, 206, 208, and 210, warping modules (warpers) 212, 214, 216, 218, image fusing modules (fusers) 236 and 238, and display modules 240, 242.

Each input is coupled to an enhancement module 202, 204, 206, 208 and 210 where the images are processed to remove non-uniformities and noise. Using warping modules 212, 214, 216 and 218, the images are then warped into sub-pixel alignment with one another. The aligned images are then coupled to the fusing modules 236 and 238, wherein the imagery on a sub-frame basis is fused into a single image for display. In other words, a portion of a frame of video of a first video signal is fused with a portion of a frame of video of a second video signal. Up to N video signals could be fused, where N is an integer greater than or equal to 2. The output is coupled to the display module 240 and 242, wherein overlay graphics and image adjustments can be made to the video for display. This process, as shall be described in detail below, processes the images on a sub-frame basis such that the first line of captured imagery from each sensor is aligned, fused and displayed before the last line of the frame is input to the video processor 114. In one embodiment of this invention that processes images with 1280 lines of information, the display begins to be created after approximately 58 lines of delay.

The video processor 114 comprises various elements that support the pipelined image fusing process. These processes are either integral to the pipelined process or are used for providing enhanced image processing and other functionality to the video processor 114. For example, the fused images generated by fusing modules 236 and 238 can be compressed using, for example, MJPEG-encoder 244. Alternatively, MPEG-2 or other forms of video compression can be used. The compressed images can be efficiently stored in memory or transmitted to other locations. The output of the encoder 244 is coupled to memory management modules 252 and 254, such that the encoded images can be stored in SDRAM 256. When those images are retrieved from the memory 256, they are coupled through a decoder 258. One exemplary use of the stored video is for recall and playback of a previous segment of captured video such that a user can review a scene that was previously imaged. In addition, the decompressed images are either used within the processor 114, transmitted to other locations, or output through the USB or UARTS ports 266 and 268. A bridge 260 couples the bus 251 to the output ports 266 and 268.

The main bus 251 couples all of these modules to one another as well as to a flash memory 264 through a memory interface 262. Also connected to the main bus 251 are a device controller 246, a vision controller 248, and a system controller 250. The vision controller and system controller are, for example, ARM-11 modules that provide the computation and control capabilities for the video processor 114.

To provide many functional video processing options within the integrated circuit that forms the video processor 114, a cross-point switch module 220 is used to provide various processing choices using a switching technique. A cross-point switch 222 couples a number of processing modules 224 from an input to an output, such that video can be selectively coupled to a variety of functions. These functions include the process for creating Laplacian image pyramids (block 226), the warping function 228, various filters 230, noise coring functions 232, and various mathematical functions in the ALU 234. These various functions can be activated and used on demand under the control of the controllers 248 and 250. These functions can be applied to sub-frames and/or entire frames of buffered video, if frame-based processing is desired. Such frame-based processing can be used to produce video mosaics of a scene. As such, the present low latency video processor may be used in both sub-frame and frame-based processing. The use of a cross-point switch module to facilitate video processing is described in commonly assigned U.S. Pat. No. 6,647,150, which is hereby incorporated by reference herein.

While data is processed using a “line based” (sub-frame) method for low latency processing, any or multiple video stream(s) of this path could be sent directly to the Crosspoint module and stored in memory using the FSP (frame store port) devices. This partially processed data can then be further processed with the frame based type processing as described in, for example, U.S. Pat. No. 6,647,150. As such, both low latency processing and frame based processing can occur in parallel within the video processor 114. The results of the frame based processing can also be displayed—either to replace the low-latency processed results, or as a PIP (Picture in Picture) of the display. The frame-based processed results will have significantly more delay before they are viewed. Note that the results of the frame based processing can also be used for other than visual information, such as providing camera pose or camera position information to the display as numerical or graphical information, as data stored in memory, or transmitted to other systems through the USB or other interfaces.

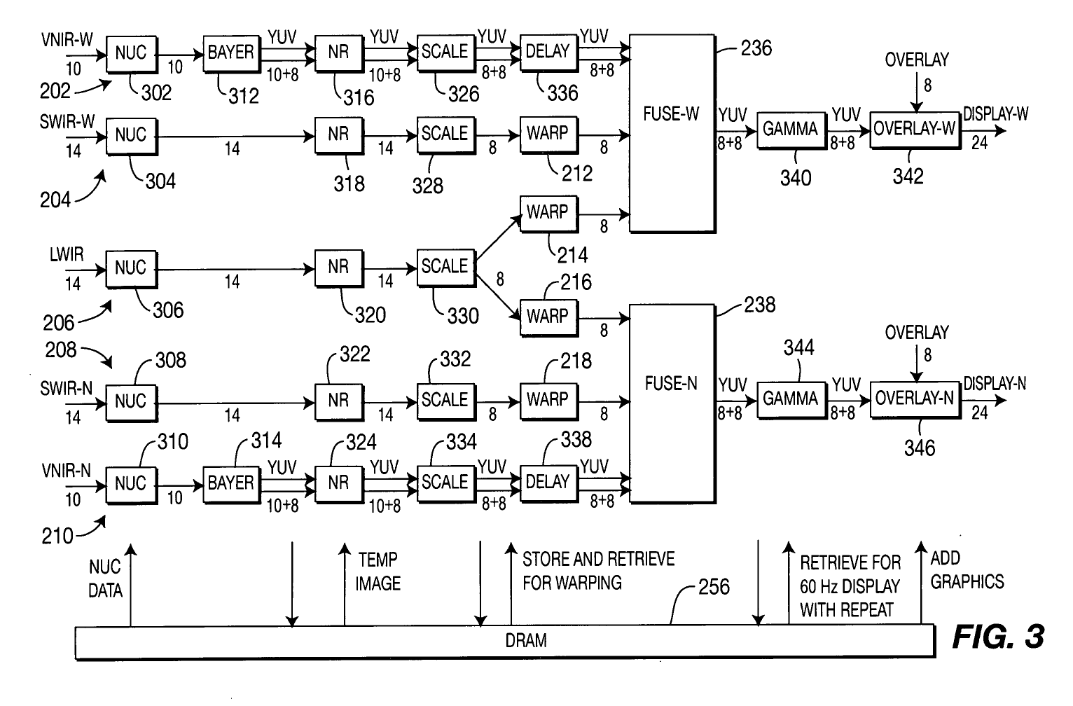

FIG. 3 depicts a detailed block diagram of the pipelined process used for fusing the images that form the core of the present invention. This process receives the multiple input video streams, aligns the streams on a sub-pixel basis, fuses the video streams on a line-by-line basis, and displays a composite fused image with a delay of less than one video frame. The enhancement modules 202, 204, 206, 208 and 210 comprise various processes that improve the video before it is aligned and fused. These enhancement features are generally well-known processes that are usually performed within a camera module or as discrete integrated circuits coupled to the camera imaging elements; however, in this implementation the enhancement features are embedded into the video processor to provide a single integrated circuit that can be coupled directly to the “raw” video from the cameras 102. Such an implementation enables the CCD arrays to be mounted on the video processor to create a “vision system on a chip”.

The selection of the type of enhancement that is performed depends on the type of imagery that is generated by the camera. Each of the cameras generally creates video using a charge coupled device (CCD) array. These arrays generally produce video that contains certain non-uniformities. As such, the video is coupled to a non-uniformity correction (NUC) circuit 302, 304, 306, 308 and 310 that, in a conventional manner, corrects for the non-uniformities in the sensor array. This non-uniformity correction can actually be performed at the camera (if the camera is remote from the video processor 114) or within the video processor 114 (as shown).

Conventional Bayer filtering is performed using Bayer filter modules 312 and 314 upon the visible wavelength, color video. In a well-known manner, Bayer filtering provides color conversion for the color cameras.

Spatial and temporal noise reduction is performed using noise reduction modules are 316, 318, 320, 322 and 324. The noise reduction processing includes spectral shaping, noise coring, temporal filtering, and various other noise reduction techniques that improve the video before it is further processed. Such filtering, for example, mitigates speckle and Gaussian noise within the images.

Since the cameras produce various accuracy video, for example, either 14-bit or 10-bit per pixel, the video must be scaled to, for example, an 8-bit precision that is used by the displays. The scaling function is performed by scalers 326, 328, 330, 332 and 334. To scale the imagery accurately, generally, certain non-uniformities may appear in the scaling process that must be compensated. Such compensation is provided by an equalization technique such as stretching the images to ensure that they are similarly scaled, and adjusting the bit accuracy of each pixel to ensure that they are uniform for each camera. Such processing generally requires the use of well-known histogram and filtering processes to ensure that the imagery is not distorted by the scaling process. This processing is performed on the video as the streams of video are provided by the cameras.

The properly scaled data streams are applied to the warping modules 212, 214, 216 and 218 to align the images to one another. The long-wavelength infrared and the short-wavelength infrared video signals are aligned to the visible near-infrared stream. Thus, the short-wave and long-wave infrared video signals are applied to the warping modules, while the visible video is merely delayed for the amount of the time that the warping modules must operate. Since the cameras are spatially aligned with one another, and the video from each camera is produced at, for example, a 30-hertz rate, the video from each camera is coarsely aligned spatially. The warping process is applied to align the video at a sub-pixel level on a block basis, e.g., a 32 line by 75 pixel block. Thus, sub-pixel alignment is performed within the warping modules 212, 214, 216 and 218 to ensure that all the images are aligned as they are generated from the CCD cameras.

The warping modules 212, 214, 216, and 218 store a number of lines of video, e.g., 32 lines, to facilitate motion estimation. The temporary storage of these lines may be SDRAM (256 in FIG. 2), Flash memory 264 or other on-chip memory. The lines of stored data are divided into a specified pixel length segments (e.g., to form 32 line by 75 pixel blocks). The blocks are analyzed to estimate motion within each block and then the blocks are warped using conventional image alignment transformations to achieve alignment amongst the blocks from different cameras. The warping process achieves sub-pixel alignment. As each line of video signal is available, new blocks are produced and aligned.

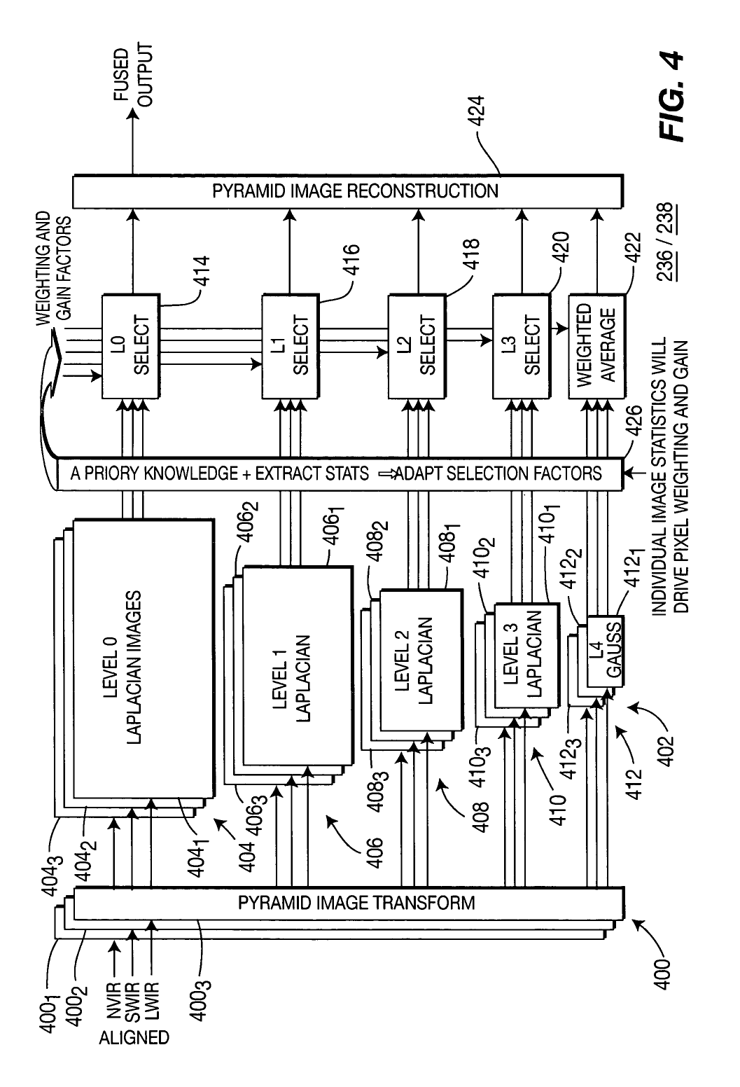

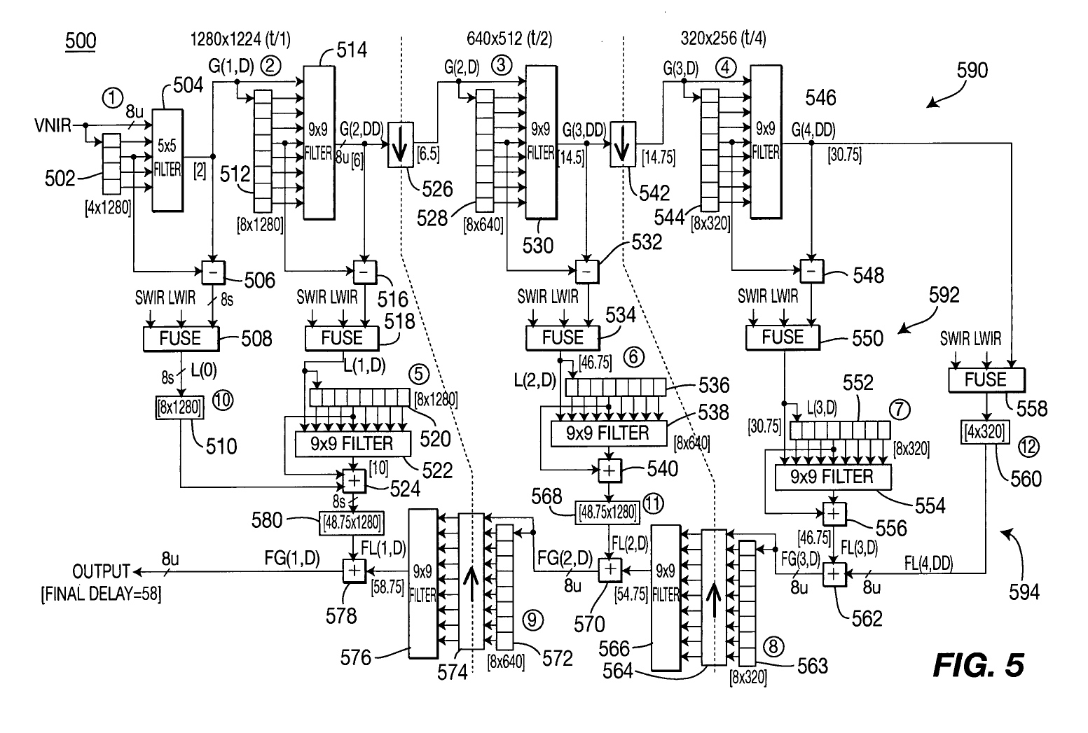

The fusing module 236, 238 processes each of the three inputs in parallel using a “double-density” process to form Laplacian pyramids having a plurality of levels. The processing that occurs in the fusing modules 236 and 238 shall be discussed with respect to FIGS. 4 and 5. In short, the levels of each pyramid of each video stream are combined with one another, then the combined levels are reconstructed into a video stream containing the image information provided by each of the cameras.

The fused output is generally stored in memory (a frame buffer) such that the frames can be stored at a 30 Hz rate and retrieved to form a 60 Hz refresh rate for the displays. As the frames are retrieved from memory, the frames are applied to a gamma adjustment module 340, 344 that adjusts the video for display. The adjusted video is then applied to an overlay generator 342, 346 that allows overlay graphics to be placed upon the video output to the display to annotate certain regions of the display or otherwise communicate information to the user.

During this image fusing process, information is supplied to and retrieved from the DRAM 256. For example, the DRAM 256 provides the NUC data for each of the sensors to correct the non-uniformities that occur in those sensors. It also provides the filter information for noise reduction, as well as storing and retrieving stored information and video data that is used in the warping process to align images, and allows the output display driver to retrieve and repeat imagery that is generated by the fusing modules on a 30-hertz rate to generate the output at a 60-hertz rate for the user. Overlay graphics are also stored within the DRAM 256 and applied to the overlay modules 342, 346, as needed. The DRAM 256 also enables images to be retrieved and supplied to the overlay modules 342, 346 to create a picture-in-a-picture capability.

FIG. 4 depicts one of the fusing modules 236 or 238, the other module is identical. The aligned video is applied to the pyramid image transform modules 400 that process the input video to produce a Laplacian pyramid 402. Each video input stream has its own pyramid transform module 400₁, 400₂ and 400₃ that applies the video, in parallel, to various Laplacian filters to form the levels of the image pyramid 402. Level zero is represented by blocks 404, including 404₁, 404₂ and 404₃. Level one is represented by blocks 406, including 406₁, 406₂ and 406₃. Level two is represented by blocks 408, including 408₁, 408₂ and 408₃, and level three of the Laplacian pyramid is represented by blocks 410, including 410₁, 410₂ and 410₃, and finally, a Gaussian level 412 is represented by 412₁, 412₂ and 412₃. Thus, the video signal from each camera 102 is decomposed into a plurality of Laplacian and Gaussian component levels. In the exemplary embodiment, four Laplacian levels and one Gaussian level is used. Other implementations may use more or less levels.

The Laplacian transform creates component patterns (levels) that take the form of circularly symmetric Gaussian-like intensity functions. This Laplacian pyramid transform 400 creates the pyramid 402, and shall be described in detail with respect to FIG. 5. Component patterns of a given scale tend to have large amplitude where there are distinctive features in the image of about that scale. Most image patterns can be described as comprising edge-like primitives. The edges are represented within the pyramid by a collection of component patterns. Frame-based pyramid processing is described in detail in commonly-assigned U.S. Pat. Nos. 5,963,675, 5,359,674, 6,567,564, and 5,488,674, each of which is incorporated herein by reference.

One embodiment of a method of the invention for forming a sub-frame composite video signal from a plurality of source video signals comprises the steps of transforming the source video into a feature-based representation by decomposing each source sub-frame image Iₙ (i.e., a small number of lines of video) into a set of component patterns Pₙ(m) using a plurality of derivative functions, such as Laplacian filters or gradient based oriented filters or wavelet type filters; computing a saliency measure for each component pattern; combining the salient features from the source video by assembling patterns from the source video pattern sets Pₙ(m) guided by the saliency measures Sₙ(m) associated with the various source video; and constructing the fused composite sub-frame image I_{c} through an inverse pyramid transform from its component patterns P_{c}(m). A saliency estimation process is applied individually to each set of component patterns Pₙ(m) to determine a saliency measure Sₙ(m) for each pattern. In general, saliency can be based directly on image data, Iₙ, and/or on the component pattern representation Pₙ(m) and/or it can take into account information from other sources. The saliency measures may relate to perceptual distinctiveness of features in the source video, or to other criteria specific to the application for which fusion is being performed (e.g., targets of interest in surveillance).

The invention uses a pattern selective method of image fusion based upon the use of Laplacian filters (component patterns) to represent the image and a double density sampling and filtering approach that overcomes the shortcomings of previously used pyramid processing methods and provides significantly enhanced performance. (Other options described in the referenced patents use oriented gradient pyramid approach, which could also be used with the double density sampling technique). Each source video signal is decomposed into a plurality of video signals of different resolution (the pyramid of images) forming the component patterns. The component patterns are, preferably edge-like pattern elements of many scales using the pyramid representation, improving the retention of edge-like source image patterns in the composite video. A pyramid is used that has component patterns with zero (or near zero) mean value. This ensures that artifacts due to spurious inclusion or exclusion of component patterns are not unduly visible. Component patterns are, preferably, combined through a weighted selection process. The most prominent of these patterns are selected for inclusion in the composite image at each scale. A local saliency analysis, where saliency may be based on the local edge energy (or other task-specific measure) in the source images, is performed on each source video to determine the weights used in component combination. Weights can also be obtained as a nonlinear sigmoid function of the saliency measures. Selection is based on the saliency measures Sₙ(m). The fused video I_{c} is recovered from P_{c} through an inverse pyramid transform.

In standard Laplacian pyramids, every level is decimated after each Gaussian filter. This decimation (or subsampling) is justified because the Gaussian filters provide typically sufficient lowpass filtering to minimize aliasing artifacts due to the sampling process. However, the fusion process of selecting different source data for every pixel based on its local saliency, enhances the aliasing effects. Therefore by representing the pyramid data at double the sampling density, these type of artifacts are significantly reduced. The double density pyramid is achieved by eliminating the first decimation step before the computation of the second pyramid level. Therefore, all pyramid data at level 1 and higher is represented at twice the standard sampling density. To achieve the same frequency responses for the levels of the pyramid, the filters applied to the double density images, use a modified filter kernel. For example, if the standard Gaussian filter uses filter coefficients (1,4,6,4,1), then the filter applied to the double density images can be (1,0,4,0,6,0,4,0,1) to achieve the equivalent filter function. This double density pyramid approach overcomes artifacts that have been observed in pixel-based fusion and in pattern-selective fusion within a standard Laplacian pyramid and can also improve the performance of oriented gradient pyramid implementations. An example of the double density Laplacian Pyramid implementation is detailed in FIG. 5.

An alternative method of fusion computes a match measure M_{n1,n2}(m,) between each pair of images represented by their component patterns, Pₙ₁(m,) and Pₙ₂(m,). These match measures are used in addition to the saliency measures Sₙ(m,) in forming the set of component patterns P_{c}(m,) of the composite image. This method may be used as well when the source images are decomposed into several gradient based oriented component patterns.

Several known oriented image transforms satisfy the requirement that the component patterns be oriented and have zero mean. The gradient pyramid has basis functions of many sizes but, unlike the Laplacian pyramid, these are oriented and have zero mean. The gradient pyramids set of component patterns Pₙ(m) can be represented as Pₙ(i, j, k, l), where k indicates the pyramid level (or scale), l indicates the orientation, and i, j the index position in the k, l array. The gradient pyramid value Dₙ(i, j, k, l) is the amplitude associated with the pattern Pₙ(i, j, k, l). It can be shown that the gradient pyramid represents images in terms of gradient-of-Gaussian basis functions of many scales and orientations. One such basis function is associated with each sample in the pyramid. When these are scaled in amplitude by the sample value, and summed, the original image is recovered exactly. Scaling and summation are implicit in the inverse pyramid transform. It is to be understood that oriented operators other than the gradient can be used, including higher derivative operators, and that the operator can be applied to image features other than amplitude.

In one simple embodiment of the invention, the step of combining component patterns uses the “choose max” rule; that is, the pyramid constructed for the composite image is formed on a sample by sample basis from the source image Laplacian values:
L_{c}(i,j,k)=max [L₁(i,j,k), L₂(i,j,k), . . . , Lₙ(i,j,k)]
where the function max [ ] takes the value of that one of its arguments that has the maximum absolute value.

In one alternative embodiment of the invention, the output of each of the pyramid transform modules are applied to an adaptation module 426 that analyzes the output information in each of the levels and uses that information to form statistics regarding the video, which is applied to the selection blocks 414, 418, 420 and 422 to enable each of the images that are going to be fused within those blocks to be weighted, based on the information contained in each of the levels. For example, a measure of the magnitude of a particular Laplacian level compared to the magnitudes of other levels, can be used to control boosting or suppression of the contribution of particular levels to the ultimate output video. Such a process provides for contrast control and enhancement. Other measures that can be used at each Laplacian level are histogram distribution, and total energy (i.e., sum of L²).

Once the pixels are weighted and combined, the pyramid image reconstruction module 424 applies an inverse pyramid transform and collapses all of the levels to a fused video signal, such that the output is a combination of the three inputs on a weighted basis, where the weighting is developed by the statistical analysis performed in the adaptation module 426. If an adaptation module 426 is not used, then the fused video of each level is applied to the inverse pyramid transform to produce an fused video output. The composite video is recovered from its Laplacian pyramid representation through an inverse pyramid transform such as that disclosed in U.S. Pat. No. 4,692,806. Because of the subframe (line by line) nature of this processing, the output-fused image is delayed less than a frame from the time of capture of the first line by the sensors.

FIG. 5 depicts a detailed block diagram of the process that is performed in fusing modules 236, 238. The specific process used is the double-density fusion process mentioned above. This double-density process is used to mitigate aliasing in the sub-sampled video signal. A “single density” process is described in U.S. Pat. No. 5,488,674 for use in a frame-based fusion process. In the double-density process of FIG. 5, the decimation (or subsampling) after the first level of the pyramid is eliminated as compared to the single-density process, the decimation is still in place after the second and remaining levels of the pyramid. As an alternative embodiment, the single density processing, e.g., decimating after each filtering process, as described in U.S. Pat. No. 5,488,674 could be adapted to implement the sub-frame vision processor of the present invention.

To generate Laplacian-filtered video data, the modules 236 and 238 use a process known as FSD, i.e., filter, subtract and decimate. As such, at each pyramid level, a Gaussian filter is used to produce Gaussian-filtered video, and then the Gaussian-filtered video is subtracted from the input video to produce Laplacian-filtered video. In the fusion process 500, the top portion 590 provides the deconstruction elements that filter the video and form the Laplacian pyramid levels. The central portion 592 is used for fusing the Laplacian levels of each camera to one another, and the lower portion 594 is used for reconstructing a video stream using the fused video of each Laplacian level. The process 500 is depicted for use in processing the visible near infrared video input. The short-wave infrared and the long-wave infrared imagery is processed in a separate upper portion 590 in an identical manner, and those outputs are applied to the fusing blocks in central portion 592.

The video is generated in a line-by-line manner from the CCD camera, i.e., the image that is captured is “scanned” on a line-by-line basis to produce a video stream of pixel data. As each line is generated, it is applied to a five-by-five Gaussian filter 504, as well as a line buffer 502, which stores, for example, four lines of 1280 pixels each. Each pixel is an 8-bit pixel. The five lines of information are Gaussian-filtered in a five-by-five filter 504 to produce a Gaussian distribution output, which is applied to subtractor 506. The subtractor subtracts the filter output from the third line of input video to produce a Laplacian-filtered signal that is applied to the fusing block 508. The filtering and subtraction produces the level zero imagery of the Laplacian pyramid. Additional lines of video are placed in the filter and processed sequentially as they are scanned from the cameras.

The output of filter 504 is applied to a second line buffer 512, as well as a nine-by-nine Gaussian filter 514. The line buffer is an eight-line by 1280 pixel buffer. The output of the buffer 512 is applied to the nine-by-nine filter 514. Note that there is no decimation in this level, which produces the “double-density” processing that is known in the art. The output of the Gaussian filter 514 is applied to a subtractor 516, along with the fifth line of the input video to produce the Laplacian level one that is applied to the fusion block 518. For single density processing, there would be a decimation step of the video output of filter 504, and the Gaussian filter 514 and all other nine-by-nine filters would be replaced by a five-by-five filter.

At block 526, the output of the filter 514 is decimated by dropping every other line and every other pixel from the filtered video signal. The decimated signal is applied to a line buffer 528, which is, for example, an 8 line by 640 pixel buffer. The outcome of the buffer 528 is applied to a nine-by-nine Gaussian filter 530 that produces an output that is applied to the subtractor 532. Line five of the input video is applied also to the subtractor 532 to produce the second level of Laplacian-filtered video at fuser 534.

The output of the Gaussian filter 530 is again decimated in a decimator 542, dropping every other line and every other pixel, to reduce the resolution of the signal. The output of decimator 542 is applied to a line buffer 544 and a nine-by-nine Gaussian filter 546. The output of the Gaussian filter 546 and every fifth line of the input video is applied to subtractor 548. The output of the subtractor is the level three of the Laplacian pyramid. This level is applied to the fuser 550.

The output of the Gaussian filter 546 is applied to the final fuser 558 as a Gaussian level of the pyramid. As such, the three Laplacian levels and one Gaussian level are generated. The imagery has now been deconstructed into the Laplacian levels.

Each level is fused with a similar level of the other cameras, e.g., the SWIR, LWIR and VNIR camera signals are fused on a level by level basis in fusers 508, 518, 534, 550, and 558. The fusers take the aligned imagery, pixel by pixel, and combines those pixels together by selecting one of the input signals that is most salient on a pixel by pixel basis. Several saliency functions are described above. One example is selecting the input pixel with the highest magnitude. The fusers may also include weighting functions before and after the saliency based selection to emphasize one source more than an other source, or to emphasize/de-emphasize the output of the fuse function. The fuser 558 is typically different because it fuses Gaussian signals and not Laplacian signals, in which case the three sources are typically combined as a weighted average. The weighting functions for all fusers can be either applied based on prior knowledge of the system and requirements, or can be controlled with the adaption module discussed above, providing an adaptive fusion function.

Once fused, the video, on a line-by-line basis, must be reconstructed into a displayable image. Portion 194 provides a process of combining the various levels by delaying the Gaussian fourth level and adding it to the Laplacian third level, then adding that combination to a delayed Laplacian second level and lastly adding that combination to a delayed combination of the Laplacian level one and zero. The delays are used to compensate for the processing time used during Laplacian filtering.

More specifically, the output of the fusion block 508 (fused level zero video) is applied to a delay 510 (e.g., an 8 line delay) that delays the output of the fusion block 508 while level one processing is being performed. The level one video from fusion block 518 is applied to a line buffer 520, which is coupled to a nine-by-nine Gaussian filter 522. It is well known in the art that the Laplacian pyramid levels require filtering before reconstruction. The output of the filter 522, input line five and the output of the level zero delay 510 are coupled to a summer 524. The output of the summer is delayed in delay 580 (e.g., 48 line delay) to allow processing of the other levels.

Similarly, the level two information is coupled to a line buffer 536, which couples to a nine-by-nine Gaussian filter 538. The output of the filter and the fifth line of the line buffer are coupled to a summer 540, which is then coupled to a delay 568 (e.g., sixteen lines). Also, the output of fuser 550 is coupled to a frame and line buffer 552 and a nine by nine Gaussian filter 554. The summer 556 sums the output of the filter with line five of the input video. The fuser 558 is coupled through a delay 560 (four line delay to summer 562. The summer 562 sums the output of the filtered level three video with the Gaussian level. Once those two signals are added to one another, the line information is coupled to a line buffer 563, which feeds an upsampler 564 that doubles the number of lines and doubles the pixel number. The output of the upsampler is filtered in a nine by nine Gaussian filter 566, which is then coupled to a summer 570. The summer 570 adds the level two information to the level three information. That output is now coupled to line buffer 572, which feeds an upsampler 574, again doubling the line and pixel numbers) that then couples to another nine by nine Gaussian filter 576. The output of the filter is coupled to the summer 578 that couples the Laplacian level zero and level one video to the Laplacian level two, three and the Gaussian level four video to produce the output image. The fused output image is generated 58 lines after the first line enters into the input at filter 504. The amount of delay, of course, is dependent on the number of levels within the pyramid that are generated.

One embodiment of an application for the processor of the present invention is to utilize the video information produced by the system to estimate the pose of the cameras, i.e., estimate the position, focal length and orientation of the cameras within a defined coordinate space. Estimating camera pose from three-dimensional images has been described in commonly assigned U.S. Pat. No. 6,571,024, incorporated herein by reference. When the system 100 of the present invention is mounted on a mobile platform, e.g., helmet mounted, aerial platform mounted, robot mounted, and the like, the camera pose can be used as a means for determining the position of the platform.

To enhance the position determination process using camera pose, the pose estimation process can be augmented with position and orientation information collected from other sensors. If the platform is augmented with global positioning receiver data, inertial guidance and/or heading information, this information can be selectively combined with the pose information to provide accurate platform position information. Such a navigation system is referred to herein as a vision-aided navigation (VAN) system.

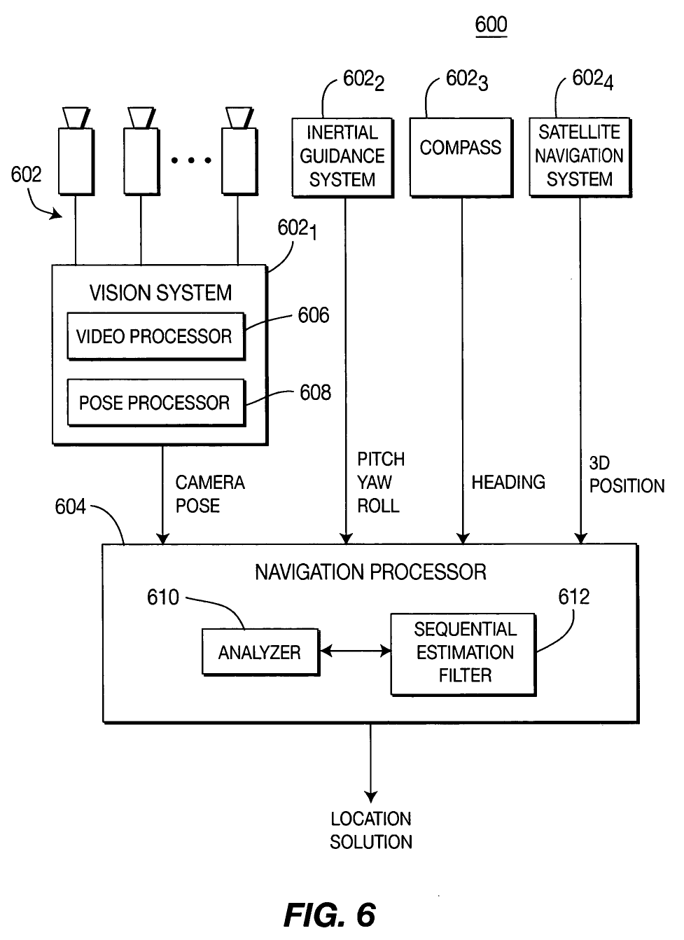

FIG. 6 depicts a block diagram of one embodiment of a VAN system 600. The system 600 comprises a plurality of navigation subsystems 602 and a navigation processor 604. The navigation subsystems 602 provide navigation information such as pitch, yaw, roll, heading, geo-position, local position and the like. A number of subsystems 602 are used to provide this information including, by way of example, a vision system 602₁, an inertial guidance system 602₂, a compass 602₃, and a satellite navigation system 6024. Each of these subsystems provides navigation information that may not be accurate or reliable in all situations. As such, the navigation processor 604 processes the information to combine, on a weighted basis, the information from the subsystems to determine a location solution for a platform.

The vision system 602₁ comprises a video processor 606 and a pose processor 608. In one embodiment of the invention, the pose processor 608 may be embedded in the vision processor 606 as a function that is accessible via the cross point switch. The vision system 602₁ processes the imagery of a scene to determine the camera orientation within the scene (camera pose). The camera pose, can be combined with knowledge of the scene (e.g., reference images or maps) to determine local position information relative to the scene, i.e., where the platform is located and in which direction is the platform “looking” relative to objects in the scene. However, at times, the vision system 602₁ may not provide accurate or reliable information because objects in a scene may be obscured, reference data may be unavailable or have limited content, and so on. As such, other navigation information is used to augment the vision system 602₁.

One such subsystem is an inertial guidance system 602₂ that provides a measure of platform pitch, roll and yaw. Another subsystem that may be used is a compass that provides heading information. Additionally, to provide geolocation information, a satellite navigation system (e.g., a global position system (GPS) receiver) may be provided. Each of these subsystems provides additional navigation information that may be inaccurate or unreliable. For example, in an urban environment, the satellite signals for the GPS receiver may be blocked by buildings such that the geolocation is unavailable or inaccurate. Additionally, the inertial guidance system accuracy of, in particular, a yaw value is generally limited.

To overcome the various limitations of these subsystems, their navigation information is coupled to a navigation processor 604. The navigation processor comprises an analyzer 610 and a sequential estimation filter 612 (e.g., a Kalman filter). The analyzer 610 analyzes navigation information from the various navigation subsystems 602 to determine weights that are coupled to the sequential estimation filter 612. The filter 612 combines the various navigation information components on a weighted basis to determine a location solution for the platform. In this manner, a complete and accurate location solution can be provided. This “location” includes platform geolocation, heading, orientation, and view direction. As components of the solution are deemed less accurate, the filter 612 will weight the less accurate component or components differently than other components. For example, in an urban environment where the GPS receiver is less accurate, the vision system output may be more reliable (thus weighted more heavily) versus the GPS receiver geolocation information.

One specific application for the system 100 is a helmet mounted imaging system comprising five sensors 102 imaging various wavelengths and a pair of displays that are positioned proximate each eye of the wearer of the helmet. The pair of displays provides stereo imaging to the user. Consequently, a user may “see” a stereo video imagery produced by combining and fusing the imagery generated by the various sensors. Using dichoptic vision, as described above, the wearer can be provided with a large field of view as well as a presentation of high resolution video, e.g., 70 degree FOV in one eye and 30 degree FOV in a the other eye. Additionally, graphics overlays and other vision augmentation can be applied to the displayed image. For example, structures within a scene can be annotated or overlaid in outline or translucent form to provide context to the scene being viewed. The alignment of these structures with the video is performed using a well-known process such as geo-registration (described in commonly assigned U.S. Pat. Nos. 6,587,601 and 6,078,701).

In other applications of the helmet platform, the platform can communicate with other platforms (e.g., users wearing helmets) such that one user can send a visual cue to a second user to direct their attention to a specific object in a scene. The images of a scene may be transmitted to a main processing center (e.g., a command post) such that a supervisor or commander may monitor the view of each user in the field. The supervisor may direct or cue the user to look in certain directions to view objects that may be unrecognizable to the user. Overlays and annotations can be helpful in identifying objects in the scene. Furthermore, the supervisor/commander may access additional information (e.g., aerial reconnaissance, radar images, satellite images, and the like) that can be provided to the user to enhance their view of a scene.

Consequently, the vision processing system of the present invention provides a flexible component for use in any number of applications were video is to be processed and fused with video from multiple sensors.

While the foregoing is directed to embodiments of the present invention, other and further embodiments of the invention may be devised without departing from the basic scope thereof, and the scope thereof is determined by the claims that follow.

1. A method of processing video from a plurality of sensors, comprising:
creating a Laplacian pyramid for a portion of a frame of a first video signal;
creating a second Laplacian pyramid for a portion of a frame for a second video signal;
combining the first and second Laplacian pyramids at each pyramid level to form composite levels; and
constructing, using the composite levels, a portion of a fused video signal containing information from the first and second video signals.

2. The method of claim 1, wherein the portion of a frame is a plurality of lines of a video signal.

3. The method of claim 1, wherein the combining step further comprises:
determining weights associated with each video signal; and
using weights to control an amount of each video signal to form the fused video signal.

4. The method of claim 3, wherein the determining step further comprises:
performing a statistical analysis of the pyramid levels to determine the weights.

5. The method of claim 4 wherein the using step further comprises:
applying the weights to the pyramid levels to determine the amount of each level to combine to form the composite levels.

6. The method of claim 1, further comprising:
enhancing the first and second video signals before creating the Laplacian pyramid.

7. The method of claim 6, wherein said enhancing step comprises at least one of non-uniformity compensation, Bayer filtering, noise reduction, and scaling.

8. The method of claim 1 further comprising:
warping the first video signal into alignment with the second video signal prior to creating the Laplacian pyramid.

9. The method of claim 1 wherein creating a Laplacian pyramid for the first video signal step comprises:
receiving a plurality of lines of a frame of the first video signal;
filtering the plurality of lines to produce a filtered signal; and
subtracting the plurality of lines from the filtered signal to produce a pyramid level.

10. The method of claim 9 wherein the creating step further comprises:
filtering the filtered signal to produce a second filtered signal;
subtracting the filtered signals from the second filtered signal to produce a second pyramid level;
decimating the second filtered signal prior to filtering the second filtered signals to produce a third filtered signal; and
subtracting the third filtered signal from the decimated second filtered signal to produce a third pyramid level.

11. The method of claim 10 wherein the constructing step further comprising:
delaying at least one composite level by a predefined number of lines;
applying an inverse pyramid transform to the composite levels to construct the portion of the fused video signal.

12. A video processor for fusing video signals from at least two video signal sources:
a warper for aligning a first video signal with a second video signal on a sub-frame and sub-pixel basis;
a first pyramid transform module for creating a first image pyramid containing first levels from a portion of the first video signal, where the portion is less than a frame;
a second pyramid transform module for creating a second image pyramid containing second levels from a portion of the first video signal, where the portion is less than a frame;
a fuser, coupled to the first and second pyramid transform modules, for fusing, on a level-by-level basis, the levels in the first and second pyramids; and
an inverse pyramid transform module, coupled to the fuser, for reconstructing a portion of a fused video signal from the fused levels.

13. The video processor of claim 12 further comprising;
an adaptation module for statistically analyzing the levels of the first and second pyramids to create weights that are used by the fuser to control level fusing.
